(19) United States
(12) Patent Application Publication
(10) Pub. No.: US 2017/0293904 A1
(43) Pub. Date: Oct. 12, 2017

(54) Validation, Subscription and Billing System

(71) Applicant: Stephen Mark Kuzara, Eagle, ID (US)

(72) Inventor: Stephen Mark Kuzara, Eagle, ID (US)

(21) Appl. No.: 15/530,415

(22) Filed: Apr. 8, 2016

(51) Int. Cl. G06Q 20/14; G06K 7/14

(52) U.S. Cl. CPC G06Q 20/145; G06K 7/1413

(57) ABSTRACT

Disclosed is a system for validating point of access customer subscription status and brokering intermediary billing adjustments. Customers can register into a water filter network. When at a food service provider location, a subscriber, when ordering water, can receive water filtered by network company's filter systems in a water storage container having a unique optical machine code that can be scanned using a smartphone application to verify the customer's subscription status via water filter manufacturer's database server. Filtered water from company's water dispensing apparatus is provided to a valid subscriber for free, while the unregistered subscriber will be required to pay full retail price for said bottle of water. The amount of water received by the validated subscriber will be deducted from the retail service bill of the service customer and the volume of water dispensed is deducted from a monthly bill of the food service provider.

### FIELD OF INVENTION

The present invention relates to systems for customer verification and retail billing. More particularly, the present invention relates to processing membership authentication of a customer at a third-party retail location.

### BACKGROUND

The amount of water available in the planet that can be used for drinking is limited. Nearly one third of the world's population does not have access to adequately clean drinking water on a regular basis. Increasingly, experts consider fresh drinking water as the most precious natural resource. Many believe we will run out of fresh drinking water before fossil fuels. As populations increase, the demand and consumption of drinking water also increases. However, the biggest threat to fresh drinking water is the development and consumerism connected to a global population increase and its corresponding increase in affluence. Rapid global increase in populations causes exponential demand for water consumption for industrial and agricultural demands. The increased demand of natural resources also results in increased pollution of existing water sources. All water sources are highly susceptible to contamination from a variety of man-made and natural sources. Bottled water offers basic filtration and the bottled water is perceived to be cleaner and healthier. However, each bottle of bottled water carries a significant carbon footprint and bottles that are collected for recycling is less. In addition, most of the bottled water is tap water and chemicals released from the plastic bottles further compromises the cleanliness of the product.

Conventional water dispensing systems for providing filtered water to the consumers includes water dispensing stations, where the customers can pay the required amount of money for receiving a particular amount of filtered water. Some other water dispensing systems enables the customers to pay early and each will be assigned with at least one water dispensing customer account. The customers will be provided with a smart card system that can be employed for receiving the required amount of filtered water from the water dispensing systems. The amount corresponding to the volume of water received will be deducted from the account of the customer. The customers can verify the balance through a website or at the retail water dispensing locations. However, these systems do not provide packaged water as part of the subscription plan within the traditional restaurant service model. Moreover, the existing systems have no means for providing the filtered water quality information to the customers. Further, these systems cannot be employed for verifying the subscriptions status of the customers at the food service locations such as restaurants. The existing systems would not allow traditional restaurants, etc. to attract, authenticate a serve patrons who have valid subscriptions to said water network.

Hence there exists a need for water dispensing system and a method for validating retail food service customer's subscription status and brokering intermediary billing adjustments for the filtered water dispensed and served by the retail food service provider. The needed system would allow the retail food service provider to authenticate and serve water network subscribers using customers smart phone and optical machine code printed on bottle seal. When a successful authentication request is completed, the amount or type of water is automatically adjusted or deducted from retail food service provider monthly bill to water filter company. The needed system would allow the customers or the water service subscribers in a food service setting, to instantly verify a subscription status by using a mobile application on the customer's smart phone to scan the optical machine code on the water bottle seal. Further, the needed system would allow retail shops, restaurants, etc. to function as a subscriber-access point for a water filter company's filtered water. In addition, the needed system would enable the point of access capabilities to enable instant subscriber verification and food service entity billing adjustments. The needed system would allow the subscribers to access real-time water quality values and would enable the customers to verify the quality of the filtered water at retail food service provider offering said filtered water. The needed system would be a cost effective and scalable. The present invention addresses such a need.

### SUMMARY

The present invention is a system and methodology for validating a customer's subscription at a retail point of access (POA) and brokering intermediary billing adjustments for said authentication. The present invention employs a new method using the proprietary smartphone application for performing the tasks of verifying the customer's subscription status that is automatically triggered when customer scans a proprietary optical machine code located on the bottle seal. In addition to subscriber details, the authentication request data contained within the machine optical code also contains water type, amount of water, and food service provider account information. If a “valid subscriber” value is returned to the requesting subscriber, the water company cloud-based server will perform an automated brokering intermediary billing adjustments on behalf of the food service entity. The water container contains a unique optical machine code pasted on an exterior surface. The optical machine code sticker contains a variety of pertinent product and location information. This optical machine code can contain product information, date and time, quality data and relevant party information such as food service provider information.

A method for validating point of access (POA) customer subscription status and brokering intermediary billing adjustments comprises the steps of providing the water storage container having the unique optical machine code attached to the exterior surface to the customer through a point of access service partner. The optical machine code on the water container is automatically printed by the filtration system for each bottle filled at location by the food service provider. When water is ordered by customer and served by server, if said customer is a subscriber of the product manufacturer, subscriber is instructed to scan machine optical code on product package with the mobile application provided by product manufacturer. The scan will send authentication request over the mobile carrier's network to the manufacturer's database server. The database server will return a yes or no result which will be displayed on subscriber's mobile phone which will then be presented to the food service provider's wait staff or the server. If the subscription is valid, the food service provider will not charge customer for the product. If the subscription is invalid, the customer will be required to pay retail price for said product. For each valid subscription response, the manufacturer's database will automatically deduct that product cost amount from the food service provider's bill. During the process of scanning the optical machine code using the software application installed in the electronic device, a customer authentication request is send to a server over a communication network. At least one notification about a subscription status of the customer is received from the server, wherein at least one notification includes information about a valid or invalid customer. The product from the manufacturer's filter system is provided, without cost, to a validated subscriber. For an invalid or unregistered subscriber response, the food service provider will collect the price for the said product. An amount corresponding to the amount of the manufacturer's product received by the customer will be deducted from the account of the food service provider stored in the manufacturer's database server. The amount of product served for the at least one customer will be posted to the food service provider's account and thereafter the amount corresponding to the manufacturer's product that is being dispensed or served is deducted from the monthly bill of the food service provider. Then a plurality of information including the amount of product dispensed or served is posted to an account of the customer for consumption tracking and point credit purposes.

Other objects and advantages of the embodiments herein will become readily apparent from the following detailed description taken in conjunction with the accompanying drawings.

BRIEF DESCRIPTIONS OF THE DRAWINGS

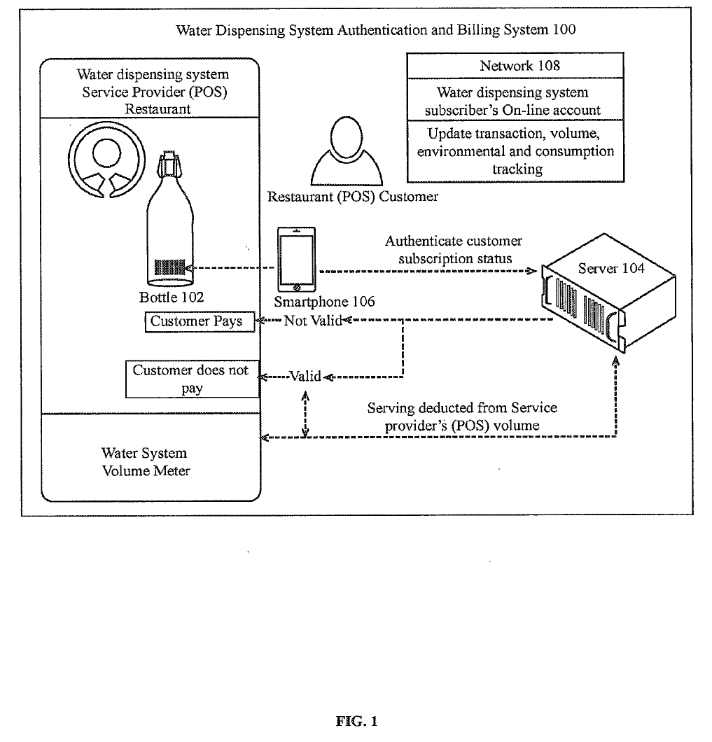

FIG. 1 is a diagram showing a computer-implemented system for validating point of access (POA) customer subscription status and brokering intermediary billing adjustments, according to a preferred embodiment of the present invention;

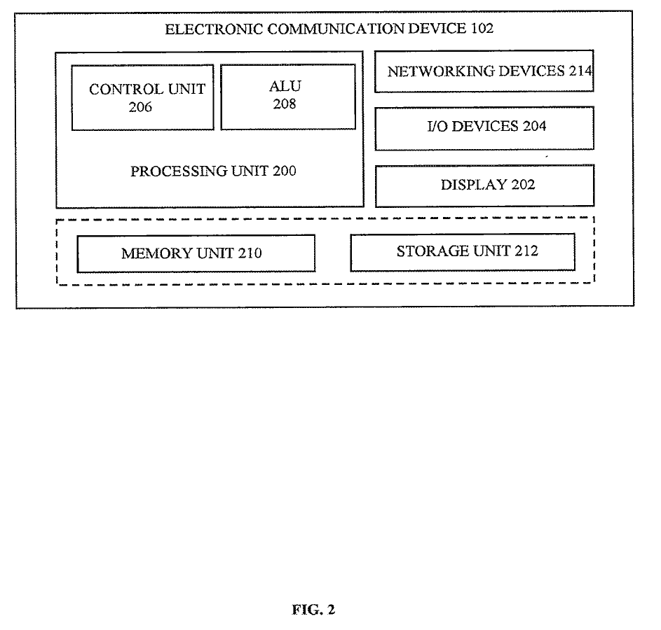

FIG. 2 illustrates a block diagram of the electronic communication device for processing the instructions of a mobile application associated with the computer implemented system for validating point of access (POA) customer subscription status and brokering intermediary billing adjustments, according to a preferred embodiment of the present invention;

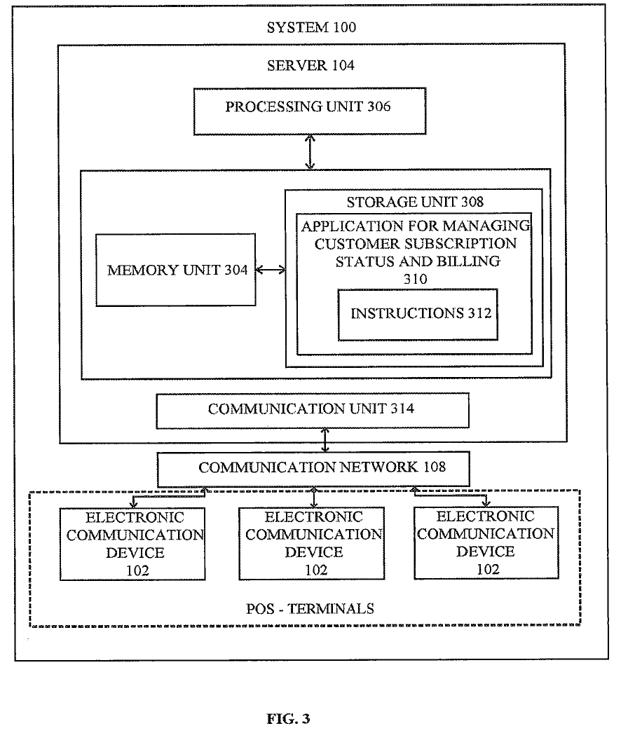

FIG. 3 illustrates a block diagram of at least one server running at least one application associated with the computer-implemented system for validating point of access (POA) customer subscription status and brokering intermediary billing adjustments, according to a preferred embodiment of the present invention; and

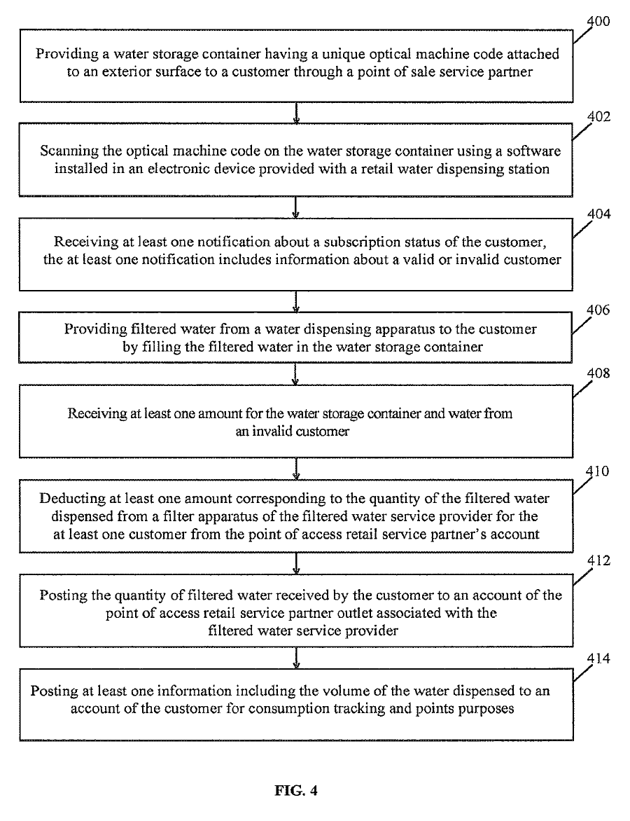

FIG. 4 illustrates a flowchart showing a method for validating point of access (POA) customer subscription status and brokering intermediary billing adjustments.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical and other changes may be made without departing from the scope of the embodiments. The following detailed description is therefore not to be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The description provided herein is complete and sufficient for those skilled in the arts of computer systems, software application development, smartphone application development and web development to implement the methods as described. One embodiment of this computer assisted system for validating point of access (POA) customer subscription status and brokering intermediary billing adjustments may employ a server running an operating system such as Windows, Linux, web-server software such as Apache, and database such as MySQL, with methods implemented through a software development language such as PHP or Java. However, the invention should not be limited to these types of software operating system, web-server software, database software, software development language, server or client hardware.

The present invention is a computer-implemented system 100 for validating point of access (POA) customer subscription status and brokering intermediary billing adjustments. According to a preferred embodiment, the system 100 disclosed in the present inventions is used for customer verification and retail service management of water dispensing systems. FIG. 1 shows the computer-implemented system 100 for validating point of access (POA) customer subscription status and brokering intermediary billing adjustments, according to a preferred embodiment of the present invention. The system 100 includes a server 104 and a plurality of electronic communication devices 106. The electronic communication devices 106 are installed with at least one software application, which is capable of scanning and identifying a unique optical machine code associated with a water storage container 102 used in the retail water dispensing systems. Consumers can register to the retail water dispensing system and will be provided with at least one water storage container 102 having the unique optical machine code imprinted on it. The unique optical machine code is selected from a group consisting of, but not limited to, a bar code, QR code or any unique identification code that can store information associated with the consumer. The unique optical machine code can store multiple information such as, but not limited to, customer information, water quality information and information related to the water dispensing systems. The software application installed in the plurality of electronic communication devices 106 are used in the retail water dispensing outlets or POS locations such as restaurants for verifying a customer's account information associated with the retail water dispensing system. The software application installed in the plurality of electronic communication devices 106 is connected to the server 104 over a communication network 108 for transferring a plurality of information for the purpose of customer verification and retail service management of the present water dispensing system. FIG. 2 illustrates a block diagram of the electronic communication device 106 for processing the instructions of a mobile application associated with the computer implemented system for validating point of access (POA) customer subscription status and brokering intermediary billing adjustments, according to a preferred embodiment of the present invention. The electronic communication device 106 comprises the at least one processing unit 200 that is equipped with a control unit 206 and an Arithmetic Logic Unit (ALU) 208, a memory unit 210, a storage unit 212, a plurality of networking devices 214 and a plurality input/output (I/O) devices 204. The electronic communication device 106 can be composed of multiple homogeneous and/or heterogeneous cores, multiple CPUs of different kinds, special media and other accelerators. The processing unit 200 may also include a memory that stores data. The processing unit 200 might include only one of a type of component e.g. one microprocessor, or may contain multiple components of that type e.g. multiple microprocessors. The processing unit 200 could be composed of a plurality of separate circuits and discrete circuit elements. In some embodiments, the processing unit 200 will essentially comprise solid-state electronic components such as a microprocessor e.g. microcontroller. The processing unit 200 may be mounted on a single board in a single location or may be spread throughout multiple locations, which cooperate to act as processing unit 200. In some embodiments, the processing unit 200 may be located in a single location e.g. in proximity and/or on a common circuit carrying element such as a circuit board and/or all the components of the processing unit 200 will be closely connected. The mobile application has an algorithm for scanning and sending the information provided in form of optical readable means on the container or bottle 102 to the server 104 for verifying the customer information and the billing status. The processing unit 200 is responsible for processing the instructions of the algorithm. The processing unit 200 receives commands from the control unit 206 in order to perform its processing. Further, the plurality of processing units 200 may be located on a single chip or over multiple chips. In addition, any logical and arithmetic operations involved in the execution of the instructions are computed with the help of the ALU 208. The memory unit 210 stores the scanned unique optical machine code data during run-time i.e. while performing automatic verification of the customer information and the billing information.

The electronic communication device 106 includes a variety of hardware and associated software components, where the variety of hardware components include the at least one processing unit 200 designed to control various other circuits such as information displayed on a display 202. The display 202 can display the user interface of the mobile application. Moreover, the display 202 may include at least one touch screen technology allowing the plurality of users or the service personal at the point of access locations or the retail water dispensing locations to control the user interface of the mobile application or the website using at least one gesture or touch. The processing unit 200 may control the information based on inputs received from various input-output (I/O) devices 204 of the electronic communication device 106 e.g. hard keys, a touch screen, voice commands from a microphone or a microphone connected to headset jack, and/or from some other user input device.

Before describing aspects of the present invention in detail, it is helpful to first discuss the environment in which embodiments of the invention operate. Referring now to FIG. 2, the electronic communication device 106 such as, but not limited to, a Smartphone, tablet, ultrabook, laptop, smart wearable device including Google Glass, Smartwatch etc., includes the at least one processing unit 200 configured to process a number of applications including the mobile application or website associated with the computer implemented system 100 for validating point of access (POA) customer subscription status and brokering intermediary billing adjustments. The mobile application installed in the electronic communication device 106 allows the plurality of users or the service personal at the retail water dispensing locations (POA) to login to submit a plurality of information including information obtained by scanning the unique optical machine code on at least one water-dispensing container 102 of the customer through a user interface. The processing unit 200 processes the plurality of inputs related to the scanned unique optical machine code and retrieves the associated information and transfers the information to the server 104 for further processing and retrieving information about the customer subscription status and brokering intermediary billing adjustments. In an embodiment of the present invention, the at least one processing unit 200 is configured to process a plurality of instructions received from the server 104. The server 104 can receive updated information about quality of water dispensed through the retail water dispensing locations (POS locations) from the water quality analyzing equipment installed at predetermined locations. The mobile application or the website allows the users or the service personal at the retail water dispensing locations to submit a plurality of information in form of text and image formats through the user interface for submitting to the server 104. The server 104 includes software for receiving, storing and retrieving the plurality of customer information, billing information and water quality information. The mobile application has the capability to launch the at least one camera module and can access a storage area of the electronic communication device 106 for storing or retrieving at least one information related to the retail water dispensing system.

The electronic communication devices 106 can be connected to a computer, or server 104 of the water dispensing systems through the software application. The software application can be a mobile application, which is having an interface with a plurality of options for enabling the personal associated with the retail water dispensing system to verify the account information of at least one customer and other billing information. In an embodiment, the mobile application may include a touch friendly user interface allowing the user to access the plurality of options related to the account information of at least one customer and other billing information associated with the retail water dispensing system. In some other embodiments, the mobile application may allow the user to access at least one server 104 having a database of all the customers registered into the retail water dispensing system. The database stores the account information of each customer including the purchase information and billing information. The mobile application may further allow the user or the POS service person to access a payment gateway associated with the server 104 to verify or receive payment from at least one customer thereby enabling the customer to receive at least one service such as prepaid water dispensing from the retail water dispensing system. The mobile application can access a plurality of hardware components of the electronic communication device 106, where the hardware components may include a camera of the electronic communication device 106 for scanning at least one unique optical machine code such as a bar code, QR code etc. provided on the container or the bottle 102. The unique optical machine code stores the customer information. The mobile application installed in the electronic communication devices 106 can be employed to scan and read the data at the retail water dispensing system locations (POA). Hence the mobile application can directly read the customer information and can communicate with the server 104 over the communication network 108 to verify customer account information and to gather information about the billing status of the customer.

The smartphone application associated with the retail water dispensing system can be launched from the electronic communication device 106 such as a Smartphone or a tablet computer and can be used to capture and retrieve information associated with the unique optical machine code imprinted on the water storage container 102. In an alternate embodiment, the system 100 for validating point of access (POA) customer subscription status and brokering intermediary billing adjustments comprises an online application or a website accessible via any networkable device such as a PC, laptop, desktop, tablet, smart wearable devices, etc. or a mobile application capable of being installed in the plurality of electronic communication devices 106 for obtaining at least one information about the water quality information, subscription status of the consumer, etc. from the server 104. The server 104 stores and processes the information including the customer subscription status, real time water quality information received from the multiple water quality monitoring systems such as digital dynamic sensor arrays (DDSA) associated with the water filtration and water quality monitoring system. The users will be provided with unique user credentials for logging into the website and the mobile application designed for providing the customer subscription information and the water quality information.

FIG. 3 illustrates a block diagram of at least one server 104 running at least one application associated with the computer-implemented system 100 for validating point of access (POA) customer subscription status and brokering intermediary billing adjustments, according to a preferred embodiment of the present invention. The server 104 runs at least one application associated with the system 100 for validating point of access (POA) customer subscription status and brokering intermediary billing adjustments. The plurality of electronic communication devices 106 for scanning the unique optical machine code on the containers 102 may be used to access the server 104, at which an instantiation of a computer-based application, which provides the network-based and other features discussed below, may be installed and accessible. Such access may be by way of a computer network or communication networks 108, such as the network of networks commonly known as the Internet. In some cases, the communication network 108 includes a local and/or wide area network or mobile communication network. In other instances, the communication network 108 may be a local area network (LAN) of an enterprise and/or a virtual LAN, which is instantiated over the Internet or other networks of networks. The server 104 is communicatively coupled to a database, which may store records concerning customer credentials, user ratings, water quality information, historical water quality measurements, and credits, feedback details, etc.

The server 104 includes similar hardware as in a computer system which includes the processing unit 306, a network communication unit 314, at least one memory unit 304, a storage unit 308 and a plurality of I/O devices 320 for connecting to a plurality of peripheral devices including a display unit. The server 104 is run by operating system software, Firmware and includes the application for managing customer subscription status and brokering intermediary billing adjustments. The features of the application is made available to the plurality of users through the user interface of at least one web site and/or the mobile application configured to run on the plurality of electronic communication devices 106. The server 104 includes a database utility for storing a plurality of information of the customers and the POS retail outlets. The plurality of instructions 312 of the application for managing customer subscription status and brokering intermediary billing adjustments 310 executed by the processing unit 306 provides a plurality of information through the user interface of the website or the mobile application (‘App’) capable of being launched on the variety of electronic communication devices 106.

In some other embodiments, the server 104 keeps tracks of all the account information associated with the customers and the data associated with the point of sale retail outlets. The point of sale retail outlets can be a restaurant or any other place having the retail water dispensing apparatus associated with the water dispensing system of the present invention. The retail water dispensing apparatus may include water purification means for filtering the water dispensed through it. The quality of water dispensing through the retail water dispensing apparatus will be periodically sent to the server 104. The user can access at least one website associated with the water dispensing system of the present invention to gain access to the water quality information and the customer's billing information. The water quality information may include the quality of water dispensed through different point of sale retail outlets. In yet other embodiment, the customers and the participating point of sale retail outlets of the water dispensing system may be provided with special offers if their total billing per month exceeds a certain predetermined value. The special offers can include additional quantity of water for a particular period of time, special rates for water received through the participating point of sale retail outlets etc.

Referring back to FIG. 1, the present invention discloses a computer-implemented system 100 and methodology for validating a customer's subscription at a retail point of access (POA) terminal and brokering intermediary billing adjustments for said authentication. The present invention employs a new method using the proprietary smartphone application for performing the tasks of verifying the customer's subscription status and the billing adjustments for a customer. In some other instances, the application for customer authentication and billing adjustments can be run on a tablet, smart wearable devices, portable computer, etc. Registered customers into the system 100 will be provided with at least one container or bottle 102 with the optical machine code on its outer surface. The customers can scan the optical machine code on the surface of the bottle 102 to check the authenticity of the user and for billing adjustments at the retail point of access (POA) terminals. The authentication of a customer using the smartphone application is automatically triggered when the customer scans the proprietary optical machine code located on the bottle seal. In addition to subscriber details, the authentication request data contained within the machine optical code also includes water type, amount of water, food service provider account information, etc. If a “valid subscriber” value is returned to the requesting subscriber, the filtered water supply company's cloud-based server 104 will perform an automated brokering intermediary billing adjustments on behalf of the food service entity. The retail point of access terminals can be a food retail service provider such as a restaurant offering the services of the water supply company. The water container 102 contains a unique optical machine code pasted on an exterior surface. The optical machine code sticker contains a variety of pertinent product and location information. This optical machine code can contain product information, date and time, quality data and relevant party information such as food service provider information.

In an embodiment of the present invention, the point of access (POA) terminals associated with the retail food service providers is provided with a water filtration system of the water filter company. The service personal at the point of access terminals or the customer can utilize the water bottle or the container 102 provided by the water service company for customer authentication. For a registered customer, he/she can use the container 102 to fill water from the water filtration system available at the point of access (POA) terminals associated with the retail food service providers. After filling the bottle 102 the seal on the bottle 102 is attached with the proprietary optical machine code by the water filtration system. This optical machine code can contain product information, date and time, quality data and relevant party information such as food service provider information.

A method for validating point of access (POA) customer subscription status and brokering intermediary billing adjustments comprises the steps of providing the water storage container 102 having the unique optical machine code attached to its exterior surface to the customer through a point of access (POA) service partner. The optical machine code on the water container 102 is automatically printed by the filtration system for each bottle 102 filled at location by the food service provider. When water is ordered by customer and served by server, the customer is instructed to scan machine optical code on product package with the mobile application provided by product manufacturer, if said customer is a subscriber of the product manufacturer or the filtered water service provider. The mobile application will send authentication request over the mobile carrier's network to the manufacturer's database server 104. The database server 104 will return a yes or no result corresponding to a registered or unregistered customer, which will be displayed on subscriber's mobile phone. The customer can then present this authentication result to the food service provider's wait staff or the server. If the subscription is valid, the food service provider will not charge customer for the product. If the subscription is invalid, the customer will be required to pay retail price for said filtered water product. For each valid subscription response from the server 104, the filtered water product manufacturer's database will automatically deduct that product cost amount from the food service provider's bill.

The customers can register and subscribe to the filtered water product manufacturer or the filtered water service provider company using the mobile application or from a website of the filtered water product manufacturer. The customers will be provided with the company's water container 102. The customer will receive the water bottle or the filtered water container 102 with the optical machine code when he/she visits the point of access (POA) service partner or a retail food service provider offering the said service. The customer can show the authenticity by launching the mobile application and scanning the unique optical machine code on the bottle 102. During the process of scanning the optical machine code using the software application installed in the electronic device 102, a customer authentication request is send to the server 104 over a communication network 108. At least one notification about a subscription status of the customer is received from the server 104, wherein at least one notification includes information about a valid or invalid customer. The product from the manufacturer's filter system is provided, without cost, to a validated subscriber. For an invalid or unregistered subscriber response, the food service provider will collect the price for the said product. An amount corresponding to the amount of the manufacturer's product received by the customer will be deducted from the account of the food service provider stored in the manufacturer's database server 104. The amount of product served for the at least one customer will be posted to the food service provider's account and thereafter the amount corresponding to the manufacturer's product that is being dispensed or served is deducted from the monthly bill of the food service provider. Then a plurality of information including the amount of product dispensed or served, location, time stamp information, water quality level, etc. is posted to an account of the customer for consumption tracking and point credit purposes.

FIG. 4 illustrates a flowchart showing a method for validating point of access (POA) customer subscription status and brokering intermediary billing adjustments. The method comprises the steps of providing a water storage container having a unique optical machine code attached to an exterior surface to a customer through a point of sale service partner as shown in block 400. The optical machine code contains a plurality of information about the water in the water storage container including a filtered date and time, information about a service establishment and a unique ID. Now as in block 402, the optical machine code on the water storage container is scanned using a software application installed in an electronic device provided with a retail water dispensing station. During the process of scanning the optical machine code using the software application installed in the electronic device, a customer authentication request is send to a server over a communication network. Then as in block 404, at least one notification about a subscription status of the customer is received from the server, wherein the at least one notification includes information about a valid or invalid customer. Now as in block 406, filtered water from a water dispensing apparatus is provided to the customer by filling it in the water storage container. An amount for the bottled water will be collected from an invalid or unregistered customer at the POS retail location, as in block 408. Deducting at least one amount corresponding to the quantity of the filtered water dispensed from a filter apparatus of the filtered water service provider for the at least one customer from the point of access retail service partner's account, as shown in block 410. Posting the quantity of filtered water received by the customer to an account of the point of access retail service partner outlet associated with the filtered water service provider, as in block 412. Finally as in block 414, information including the volume of the water dispensed is posted to an account of the customer for consumption tracking and point credit purposes.

Hence the water dispensing system and method for validating retail food service customer's subscription status and brokering intermediary billing adjustments for the filtered water dispensed and served by the retail food service provider allow the retail food service provider to authenticate and serve water network subscribers using customers smart phone and optical machine code printed on bottle seal. When a successful authentication request is completed, the amount or type of water is automatically adjusted or deducted from retail food service provider monthly bill to water filter company. The system 100 allow the customers or the water service subscribers in a food service setting, to instantly verify a subscription status by using a mobile application on the customer's smart phone to scan the optical machine code on the water bottle seal which will initiate an authentication request over the subscribers cellular network to water filter manufacturer company's cloud-based server. Further, the system 100 allows retail shops, restaurants, etc. to function as a subscriber-access point for a water filter company's filtered water. In addition, the system 100 enables the point of access capabilities to enable instant subscriber verification and food service entity billing adjustments. The system 100 allow the subscribers to access real-time water quality values and would enable the customers to verify the quality of the filtered water at retail food service provider offering said filtered water. The system 100 is cost effective and scalable.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the appended claims.

Although the embodiments herein are described with various specific embodiments, it will be obvious for a person skilled in the art to practice the invention with modifications. However, all such modifications are deemed to be within the scope of the claims.

1. A system for validating point of access (POA) customer subscription status and brokering intermediary billing adjustments, the system comprising:
a water storage container having an optical machine code provided on an exterior surface,
wherein the optical machine code contains a plurality of information including a water quality information, water quantity information for the filtered water received from at least one point of access retail outlet associated with a filtered water service provider, filtered date and time and information for verifying a service establishment of a customer with the filtered water service provider;
a plurality of electronic devices installed with at least one software application capable of scanning and retrieving the plurality of information associated with the optical machine code; and
at least one server capable of communicating with the at least one software application running on the plurality of electronic devices over a communication network for providing a plurality of information including a plurality of customer information, a plurality of information about the at least one point of access retail outlet associated with the filtered water service provider, billing information and at least one water quality information.

2. The system of claim 1 wherein the optical machine code can be a sticker seal placed on the exterior surface of the water storage container provided at the point of access retail outlet associated with a filtered water service provider,
wherein the optical machine code can be scanned for retrieving the plurality of information associated with the optical machine code.

3. The system of claim 1 wherein the software application installed in the electronic device can be launched to scan the optical machine code provided on the exterior surface of the water storage container to retrieve information about a customer subscription status with the filtered water service provider from the server.

4. The system of claim 1 wherein the software application sends scanned information from the optical machine code to the server over the communication network for verifying the customer subscription status.

5. The system of claim 1 wherein the software application in communication with the server performs at least one billing adjustment for the at least one point of access retail outlet associated with the filtered water service provider based on a quantity of water received by the customer.

6. The system of claim 1 wherein the software application can run on the plurality of electronic devices selected from a group comprising of smartphone, tablet, portable computer and smart wearable devices.

7. A method for validating point of access (POA) customer subscription status and brokering intermediary billing adjustments comprises the steps of:
providing a water storage container having a unique optical machine code attached to an exterior surface of the water storage container to a customer through a point of access retail service partner outlet associated with a filtered water service provider,
wherein the optical machine code contains a plurality of information including water quality information, water quantity information for the filtered water received from at least one point of access retail service partner outlet associated with the filtered water service provider, a filtered date and time, information about a service establishment of a customer with the filtered water service provider and a unique ID;
scanning the optical machine code on the water storage container using a software application installed in an electronic device,
wherein scanning the optical machine code using the software application installed in the electronic device sends a customer authentication request to a server over a communication network;
receiving at least one notification about a subscription status of the customer,
wherein the at least one notification includes information about a valid or invalid customer;
providing filtered water from a water dispensing apparatus provided by the filtered water service provider to the customer in the water storage container,
wherein the filtered water is provided by the at least one point of access retail service partner outlet associated with the filtered water service provider;
receiving at least one amount for the water storage container with the filtered water from an invalid customer through the at least one point of access retail service partner outlet associated with the filtered water service provider;
deducting at least one amount corresponding to the quantity of the filtered water dispensed from a filter apparatus of the filtered water service provider for the at least one customer from an account of the point of access retail service partner,
wherein the amount corresponding to the volume of the water dispensed will be deducted from a monthly bill of the point of access retail service partner;
posting the quantity of filtered water received by the customer to the account of the point of access retail service partner outlet associated with the filtered water service provider,
wherein the server updates and stores the plurality of information including the at least one amount deducted from the point of access retail service partner outlet; and
posting at least one information including the quantity of the water dispensed to an account of the customer for consumption tracking and points purposes.

8. The method of claim 7 wherein the optical machine code on the exterior surface of the water storage container can be scanned using the software application running in the electronic device,
wherein the software application is in communication with the server to authenticate a customer, to perform at least one billing adjustment for the at least one point of access retail outlet associated with the filtered water service provider based on a quantity of water received by the customer and for posting the at least one information including the quantity of the water dispensed to the account of the customer for consumption tracking and points purposes.
